(19) United States
(12) Patent Application Publication
(10) Pub. No.: US 2025/0345867 A1
(43) Pub. Date: Nov. 13, 2025

(54) HANDHELD PUNCH TOOL

(71) Applicant: MILWAUKEE ELECTRIC TOOL CORPORATION, Brookfield, WI (US)

(72) Inventors: Kallol Barai, Milwaukee, WI (US); Nicholas E. Holstine, Wauwatosa, WI (US); Erik A. Freeberg, Oconomowoc, WI (US); Michael R. Rohrer, Milwaukee, WI (US)

(21) Appl. No.: 19/198,629

(22) Filed: May 5, 2025

Related U.S. Application Data
(60) Provisional application No. 63/643,650, filed on May 7, 2024.
(60) Provisional application No. 63/753,496, filed on Feb. 4, 2025.

(51) Int. Cl. B23D 27/04

(52) U.S. Cl. CPC B23D 27/04

(57) ABSTRACT

A handheld punch tool includes a housing having a handle, a battery receptacle, and a gearcase coupled to the handle opposite the battery receptacle. A cutting head is coupled to the gearcase, a drive unit is disposed within the housing, and a drive train is coupled to the drive unit. The drive train includes a transmission for providing torque to the drive unit, and a reciprocating mechanism coupled to the transmission for reciprocally driving a punch. The handheld punch tool further includes a die assembly having a die holder and a die. A die holder lock is coupled to the housing to lock the die holder thereto, and includes a plunger base coupled to the gearcase, a plunger for engaging the die holder, a fastener threaded to the plunger base, and a biasing element between the fastener and the plunger for preloading the plunger against the die holder.

### CROSS-REFERENCE TO RELATED APPLICATIONS

This application claims priority to U.S. Provisional Patent Application No. 63/753,496 filed on Feb. 4, 2025 and U.S. Provisional Patent Application No. 63/643,650 filed on May 7, 2024, the entire contents of both of which are incorporated herein by reference.

### FIELD OF THE DISCLOSURE

The present disclosure relates to power tools, and more particularly to handheld punch tools.

### BACKGROUND OF THE DISCLOSURE

Handheld reciprocating punch tools, also known as nibblers, operate by rapidly reciprocating a punch to cut through sheet metal, such as ductwork. Although nibblers are generally efficient and accurate tools for cutting through sheet metal, typical nibblers eject numerous small fragments during a cutting operation. These fragments can be sharp and difficult to clean up. In addition, typical nibblers are powered by an AC power source or compressed air, requiring a power cord or air hose that limits access and maneuverability.

### SUMMARY OF THE DISCLOSURE

The present disclosure provides, in one aspect, a handheld punch tool including a housing having a handle, a battery receptacle disposed at an end of the handle, and a gearcase coupled to the handle opposite the battery receptacle. A cutting head is coupled to the gearcase, a drive unit is disposed within the housing, and a drive train is coupled to the drive unit. The drive train includes a transmission operatively coupled to the drive unit to receive torque therefrom, and a reciprocating mechanism operatively coupled to the transmission, the reciprocating mechanism configured to convert rotational torque from the transmission into a reciprocating motion. A punch is coupled to the reciprocating mechanism to be driven in the reciprocating motion. The handheld punch tool further includes a die assembly having a die holder extending from the housing and a die coupled to the die holder. A die holder lock is coupled to the housing and configured to selectively lock the die holder thereto. The die holder lock includes a plunger base coupled to the gearcase, a plunger disposed within the plunger base and configured to selectively engage the die holder to lock the die holder to the gearcase, a fastener threaded to the plunger base, and a biasing element disposed between the fastener and the plunger, the biasing element configured to preload the plunger against the die holder in response to rotation of the fastener relative to the plunger base.

The present disclosure provides, in another aspect, a handheld punch tool includes a housing having a handle, a battery receptacle disposed at an end of the handle, and a gearcase coupled to the handle opposite the battery receptacle. A cutting head is coupled to the gearcase, a drive unit is disposed within the housing, and a drive train is coupled to the drive unit. The drive train includes a transmission operatively coupled to the drive unit to receive torque therefrom, and a reciprocating mechanism operatively coupled to the transmission, the reciprocating mechanism configured to convert rotational torque from the transmission into a reciprocating motion. A punch is coupled to the reciprocating mechanism to be driven in the reciprocating motion. The handheld punch tool further includes a die assembly having a die holder extending from the housing and a die coupled to the die holder. A trigger mechanism configured to control operation of the handheld punch tool includes a trigger switch and a power trigger coupled to the trigger switch for actuating the trigger switch between a first state corresponding with an off position, a second state corresponding with a full power position, and an intermediate state corresponding with an intermediate position between the off position and the full power position. The drive unit is configured to progressively increase speed from the off position through the intermediate position and to the full power position.

The present disclosure provides, in yet another aspect, a handheld punch tool including a housing having a handle, a battery receptacle disposed at an end of the handle, and a gearcase coupled to the handle opposite the battery receptacle. A cutting head is coupled to the gearcase, a drive unit is disposed within the housing, and a drive train is coupled to the drive unit. The drive train includes a transmission operatively coupled to the drive unit to receive torque therefrom, and a reciprocating mechanism operatively coupled to the transmission, the reciprocating mechanism configured to convert rotational torque from the transmission into a reciprocating motion. A punch is coupled to the reciprocating mechanism to be driven in the reciprocating motion. The handheld punch tool further includes a die assembly having a die holder extending from the housing and a die coupled to the die holder. A chip bag assembly is selectively coupled to the die holder. The chip bag assembly includes an adapter configured to be snap-fit to the die holder, and a chip bag coupled to the adapter. The chip bag is configured to collect chips cut by the punch and the die from a sheet of material.

The present disclosure provides, in yet another aspect, a handheld punch tool including, a housing having a handle, a battery receptacle disposed at an end of the handle, and a gearcase coupled to the handle opposite the battery receptacle. The handheld punch tool further includes a cutting head coupled to the gearcase, a drive unit disposed within the housing, a drive train coupled to the drive unit that has a transmission operatively coupled to the drive unit to receive torque therefrom, and a reciprocating mechanism operatively coupled to the transmission that is configured to convert rotational torque from the transmission into a reciprocating motion. The handheld punch tool further includes a punch coupled to the reciprocating mechanism to be driven in the reciprocating motion, a die assembly having a die holder extending from the housing and a die coupled to the die holder, and a chip bag assembly selectively coupled to the die holder. The chip bag assembly includes an adapter and a chip bag coupled to the adapter that is configured to collect chips cut by the punch and the die from the sheet of material. The handheld punch tool further includes a latch coupled to one of the adapter or the die holder, the latch is movable between a locking position, in which the adapter is secured to the die holder, and a release position, in which the adapter is removable from the die holder, and a recess defined in the other of the adapter or the die holder in which the latch is receivable in the locking position.

Other features and aspects of the disclosure will become apparent by consideration of the following detailed description and accompanying drawings.

### BRIEF DESCRIPTION OF THE DRAWINGS

FIG. 1 is perspective view of a punch tool.

FIG. 2 is a cross-sectional view of the punch tool of FIG. 1, taken along line 2-2 in FIG. 1.

FIG. 3 is a detail view of FIG. 2 illustrating a portion of the punch.

FIG. 4 is a cross-sectional view of the punch tool of FIG. 1, taken along line 4-4 in FIG. 1.

FIG. 5 is an exploded perspective view of a gearcase and die holder of the punch.

FIG. 6 is a cross-sectional view of a portion of the die holder and a schematically illustrated chip bag assembly.

FIG. 7 lower perspective view of the die holder of FIG. 5.

FIG. 8 is a perspective view of an adapter of the chip bag assembly.

FIG. 9 is a cross-sectional view of the adapter, taken along line 9-9 in FIG. 8.

FIG. 10 is a cross-sectional view of the adapter and bag.

FIG. 11 is a perspective view of the adapter and the bag of FIG. 10.

FIG. 12 is a perspective view of a trigger mechanism.

FIG. 13 is a cross-sectional view of the trigger mechanism in the off position, taken along line 13-13 in FIG. 12.

FIG. 14 illustrates the trigger mechanism in an on position.

FIG. 15 is a cross-sectional view of a die locking mechanism, taken along section line 15-15 in FIG. 1.

FIG. 16 is a cross-sectional view of a die locking mechanism in an unlocked position.

FIG. 17 is a perspective view of a portion of a punch tool illustrating a die locking mechanism in accordance with another embodiment of the present disclosure.

FIG. 18 is a cross-sectional view of the die locking mechanism of FIG. 16 in an unlocked position, taken along line 18-18 in FIG. 17.

FIG. 19 illustrates the die locking mechanism of FIG. 18 in a locked position.

FIG. 20 is a perspective view of a portion of a punch tool illustrating a die locking mechanism in accordance with yet another embodiment of the present disclosure.

FIG. 21 is a perspective view of a portion of the die locking mechanism of FIG. 20.

FIG. 22 is a cross-sectional of the die locking mechanism of FIG. 20 in an unlocked position, taken along line 22-22 in FIG. 20.

FIG. 23 illustrates the die locking mechanism of FIG. 22 in a locked position.

FIG. 24 is a perspective view of a portion of a punch tool illustrating a die locking mechanism in accordance with yet another embodiment of the present disclosure.

FIG. 25 is a perspective view illustrating a portion of the die locking mechanism of FIG. 24 in an unlocked position.

FIG. 26 is a perspective view illustrating the portion of the die locking mechanism of FIG. 25 in a locked position.

FIG. 27 is a perspective view of a chip bag assembly according to another embodiment of the present disclosure.

FIG. 28 is a cross-sectional view of a portion of a die holder and the chip bag assembly of FIG. 27.

FIG. 29 is a perspective view of an adapter for use with the chip bag assembly of

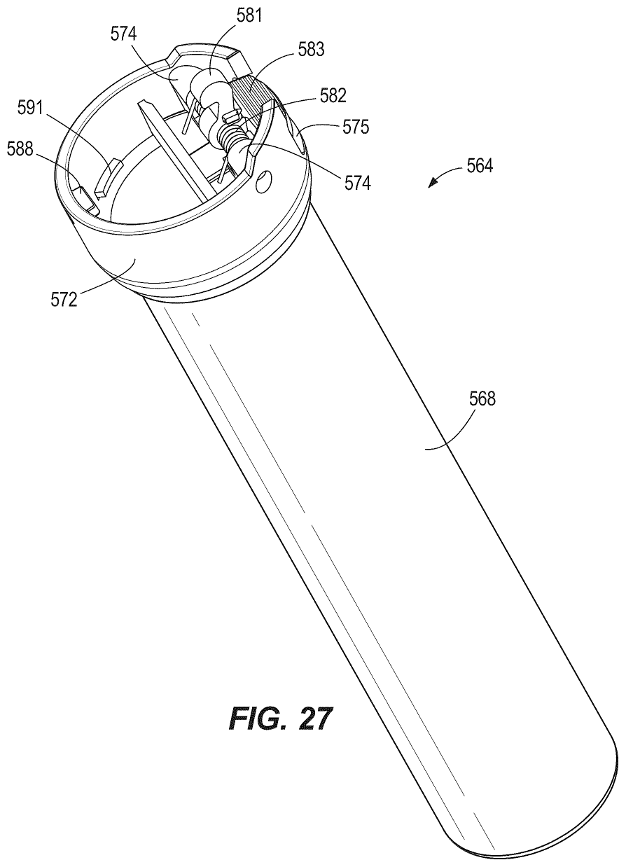

FIG. 27.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

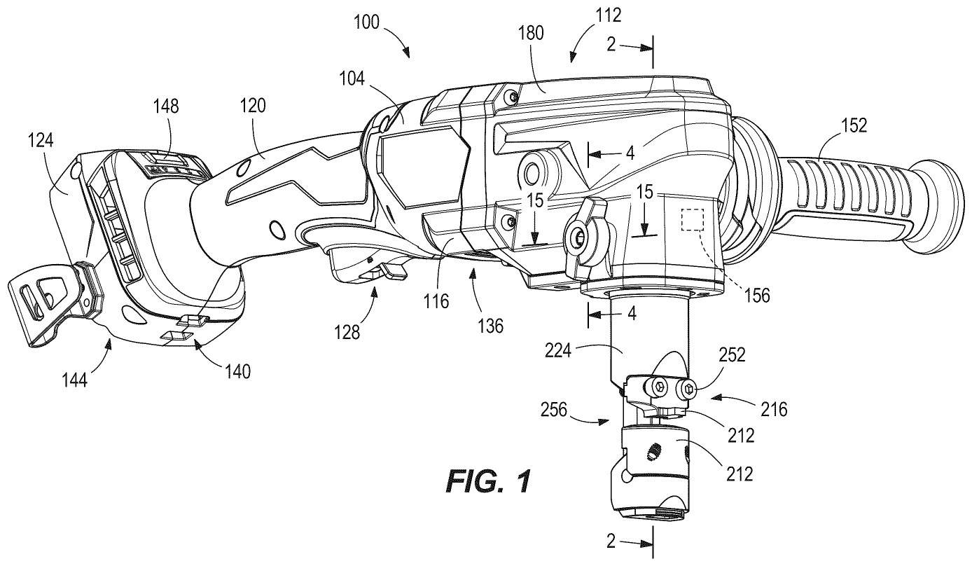

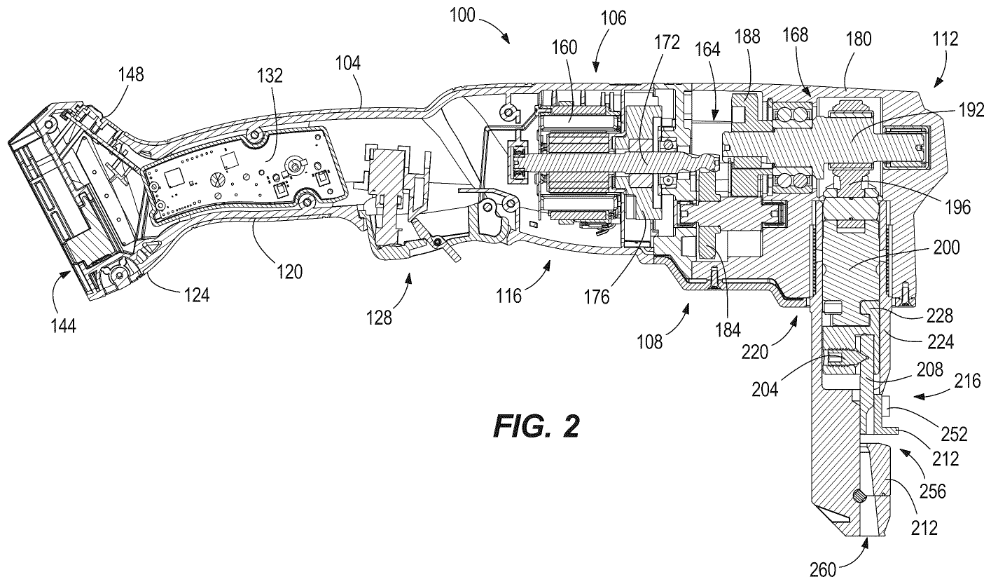

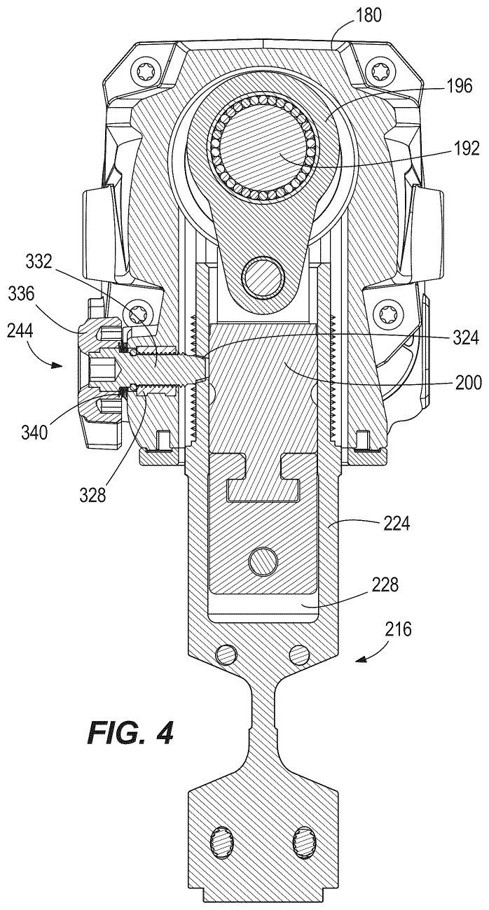

FIGS. 1-4 illustrate a handheld punch tool or nibbler 100 including a housing 104, a drive unit 106 disposed within the housing 104, a drive train 108 (FIG. 2) coupled to the drive unit 106, a cutting head 112 coupled to the housing 104 for performing a cutting operation on a sheet of material, and a battery pack (not shown) removably coupled to the housing 104 opposite the cutting head 112. The housing 104 is formed as a clamshell and includes a forward portion 116, a handle 120 extending rearward from the forward portion 116, and a foot 124 extending from the handle 120 opposite the forward portion 116. The cutting head 112 is coupled to the forward portion 116 of the housing 104. The handle 120 is generally cylindrical to provide a grip for a user during operation of the nibbler 100 and, as will be described in greater detail herein, supports a trigger mechanism 128 that controls operation of the nibbler 100. A controller 132 (FIG. 2) is disposed within the handle 120 and operatively coupled to the trigger mechanism 128, the drive train 108, and the battery pack (when the battery pack is coupled to the nibbler 100) to control operation of the nibbler 100. The housing 104 may include inlet and exhaust ports 136, 140 to allow airflow through the housing 104. The airflow may cool components of the nibbler 100 disposed within the housing 104. The foot 124 extends from the handle 120 to form a battery pack receptacle 144 to which the battery pack is selectively attachable. The battery pack is a rechargeable battery pack including a plurality of lithium-based cells. The battery pack may have a nominal output voltage of approximately 18 Volts. In some embodiments, the battery pack may have other nominal output voltages. The foot 124 further includes a user interface 148 that allows a user to control various aspects of the nibbler 100 (e.g., operating modes). A secondary or accessory handle 152 may be removably attached to the cutting head 112. The accessory handle 152 is oriented to extend transversely to a longitudinal direction of the handle 120. The accessory handle 152 allows a user to grasp the nibbler 100 with both hands during use. In some embodiments, the accessory handle 152 may be attachable to the housing 104 rather than to the cutting head 112. Finally, the cutting head 112 further includes a lighting element 156 to illuminate forward of the nibbler 100 during use. In some embodiments, the lighting element 156 may be disposed on other portions of the housing 104 rather than the cutting head 112. In other embodiments, the nibbler 100 may include a plurality of lighting elements 156 spaced about the housing 104 and/or the cutting head 112.

With continued reference to FIGS. 2-4, the drive unit 106 of the illustrated embodiment is an electric motor 160, such as a brushless DC electric motor. The drive train 108 includes a transmission 164 coupled to the electric motor 160 to receive rotational energy therefrom, and a reciprocating mechanism 168 coupled to the transmission 164. The reciprocating mechanism 168 transforms rotational energy, or torque, from the transmission 164, and thus the motor 160, to a back-and-forth reciprocating movement. In the illustrated embodiment, the reciprocating movement is along an axis that is transverse to a rotational axis of the motor. The motor 160 is disposed within the forward portion 116 of the housing 104 and includes an output shaft 172 extending forward of the housing 104 to be coupled to the transmission 164. A fan 176 is coupled to the output shaft 172 for co-rotation therewith. The fan 176 generates an airflow through the housing 104 (e.g., through the inlet and exhaust ports 136, 140) to cool the controller 132, the motor 160, and other components of the nibbler 100.

The housing 104 includes a gearcase 180 coupled to the forward portion 116 and supporting the cutting head 112. The transmission 164 and reciprocating mechanism 168 are disposed within the gearcase 180. Thus, the gearcase 180 is generally “L” shaped. The transmission 164 may be a single or multi-stage transmission that includes at least an input 184 operatively coupled to the output shaft 172 of the motor 160 and an output 188 operatively coupled to the reciprocating mechanism 168. In some embodiments, however, the reciprocating mechanism 168 may receive rotational energy directly from the motor 160. The reciprocating mechanism 168 includes an eccentric drive 192 coupled to the output 188 of the transmission 164 for co-rotation therewith. A yoke 196 is coupled to the eccentric drive 192 and to a drive rod 200. In the illustrated embodiment, the yoke 196 encompasses the eccentric drive 192 and has a pinned connection with the drive rod 200. Rotation of the output 188 of the transmission 164 causes rotation of the eccentric drive 192, which in turn moves the yoke 196. The yoke 196 translates rotation of the eccentric drive 192 into reciprocation of the drive rod 200. The drive rod 200 includes a clamp 204 disposed opposite the yoke 196, and a punch 208 is removably coupled to the drive rod 200 via the clamp 204. When attached to the drive rod 200, the punch 208 reciprocates relative to a die 212 to cut material from a sheet. The punch 208 is removable to be replaced when worn or to substitute the punch 208 for one having a different size or geometry.

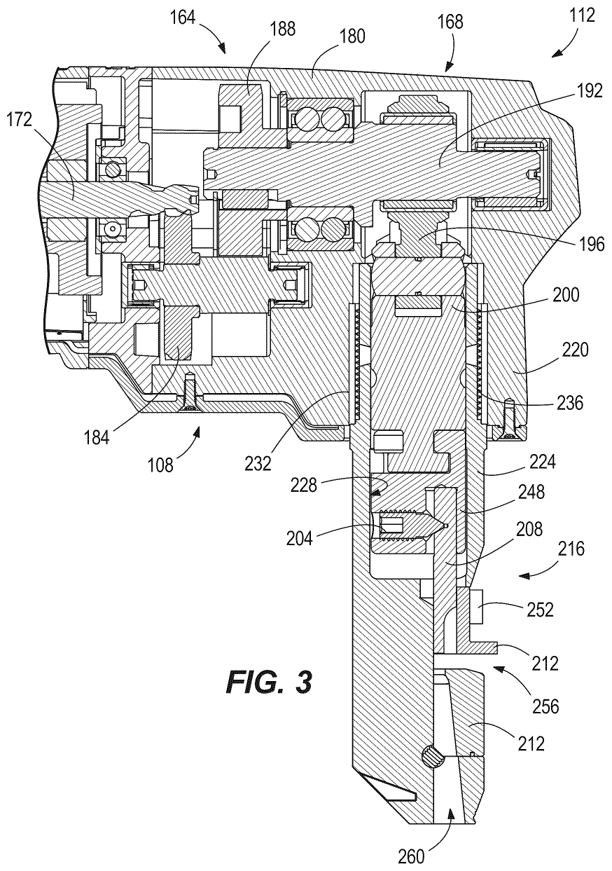

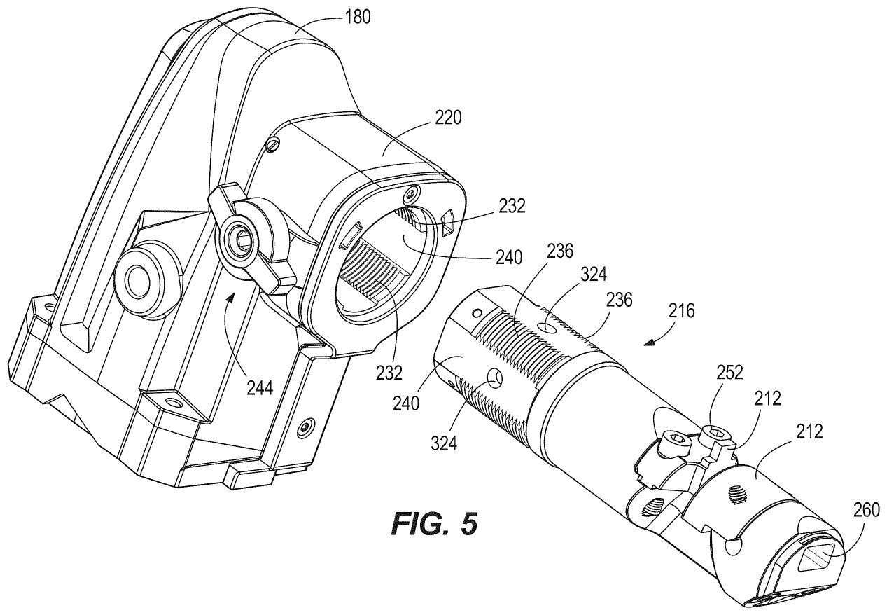

With reference to FIG. 5, a die assembly 216 is removably coupled to the gearcase 180 to position the die 212 relative to the punch 208. The gearcase 180 includes a die holder support 220 to which a die holder 224 is removably coupled. The die holder 224 is a generally tubular body that defines a cylinder 228 (FIG. 3) in which the drive rod 200 is reciprocal. The die holder support 220 includes threads 232, and the die holder 224 includes corresponding threads 236. Each of the die holder support 220 and the die holder 224 have channels 240 interrupting the threads 232, 236. The channels 240 allow the die holder 224 to be rotationally positioned such that the threads 232 of the die holder support 220 are not engaged with the threads 236 of the die holder 224. Such a rotational position allows the die holder 224 to be moved axially relative to the gearcase 180 for installation and removal. The gearcase 180 further includes a die holder lock 244 that will be described in greater detail herein. The die holder lock 244 is moveable between an unlocked position, in which the die holder 224 is movable relative to the gearcase 180, and a locked position, in which the die holder lock 244 prevents movement of the die holder 224 relative to the gearcase 180. The die holder 224 further includes a punch aperture 248 extending from the cylinder 228 to provide clearance for the punch 208 to reciprocate with the drive rod 200. The die 212 is supported by the die holder 224 adjacent to the punch 208. The die 212 is removably coupled to the die holder 224 by a die lock mechanism 252. Thus, the die 212, like the punch 208, can be conveniently removed and replaced when worn or to substitute the die 212 for one having a different size or geometry. A feed slot 256 is defined between the die 212 and the die holder 224, and a chip duct 260 extends below the die 212. The punch 208 reciprocates within the punch aperture 248 and past the feed slot 256 during operation of the nibbler 100. Sheet material to be cut is fed into the feed slot 256, and the punch 208 reciprocates relative to the die 212 to cut the sheet material against the die 212. Chips cut by the punch 208 and the die 212 drop into the chip duct 260 to be directed away from the die 212.

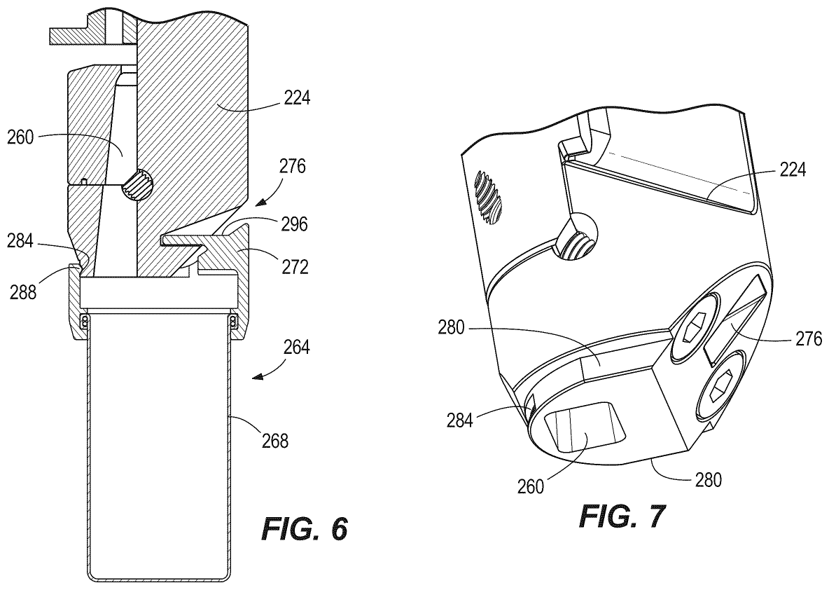

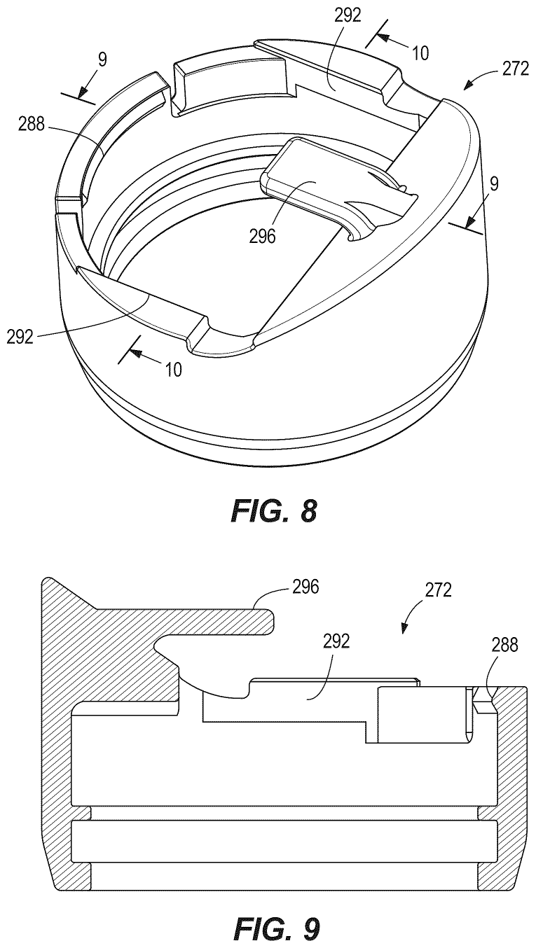

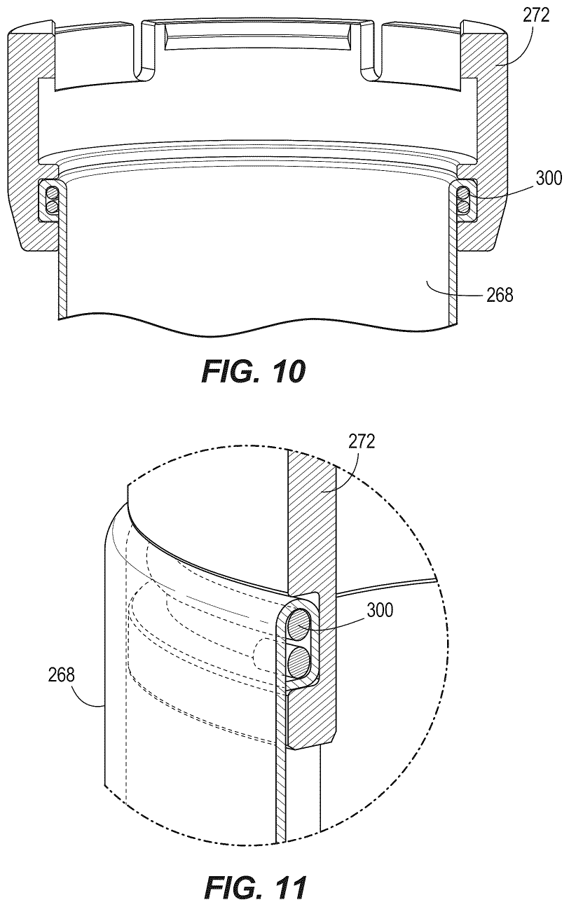

With reference to FIGS. 6-11, a chip bag assembly 264 may be removably coupled to the die holder 224 to collect cut material that is expelled via the chip duct 260. The chip bag assembly 264 includes a bag 268 and an adapter 272 coupled to the bag 268. The adapter 272 is shaped to be snap-fit to the die holder 224 to hold the bag 268 relative to the chip duct 260. In particular, the die holder 224 includes a rear lock 276, a pair of opposed positioning flats 280, and a snap feature 284. The rear lock 276 is a recess extending into the die holder that is generally triangular in cross-section. The positioning flats 280 extend on either side of the die holder 224, and the snap feature 284 is disposed opposite the rear lock 276. The snap feature 284 is also formed as a recess into the die holder 224. However, in other embodiments, the snap feature 284 may be formed as a projection or combination of projections and recesses. The adapter 272 includes a corresponding snap feature 288, a pair of positioning protrusions 292 that correspond to the positioning flats 280, and a rear locking protrusion 296. The snap feature 288 is a protrusion shaped to be received within the recess of the snap feature 284 of the die holder 224. The rear locking protrusion 296 extends in such a way to be positioned within the rear lock 276 when the adapter is coupled to the die holder 224. FIGS. 10 and 11 illustrate cross-sectional views of the adapter 272 and a portion of the bag 268. A retaining ring 300 is disposed between the bag 268 and the adapter 272 to secure the bag 268 to the adapter 272.

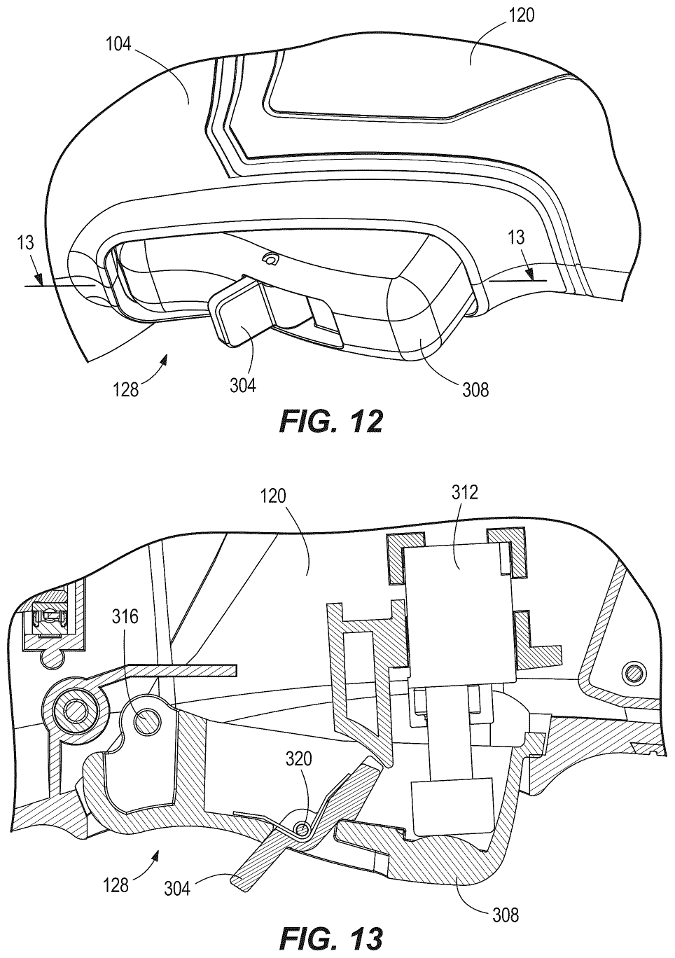

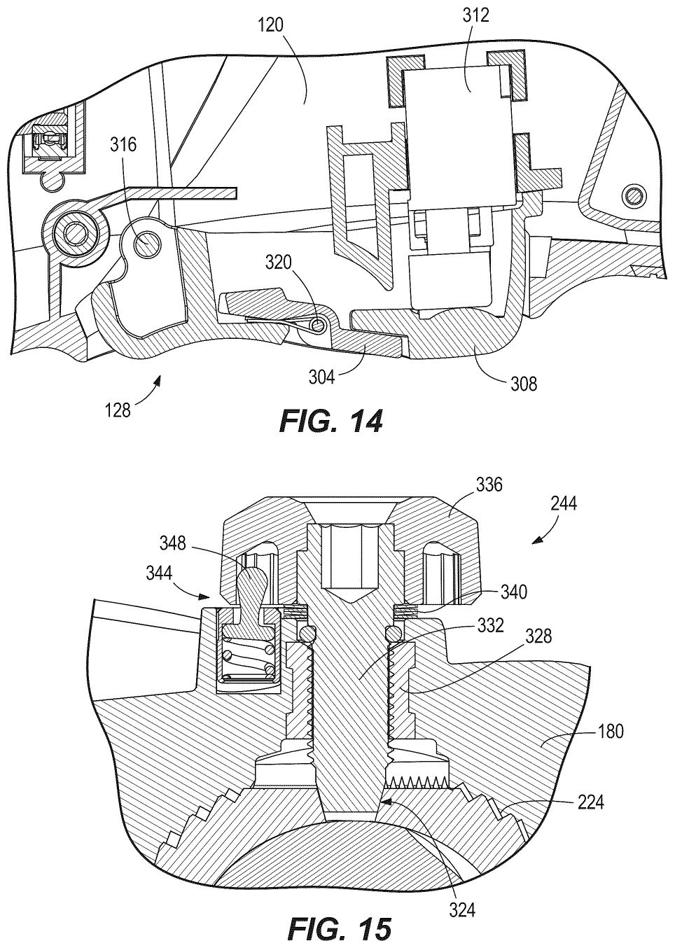

FIGS. 12-14 illustrate the trigger mechanism 128 in further detail. The trigger mechanism 128 is a dual trigger design that includes a safety trigger 304 and a power trigger 308. The safety trigger 304 provides a mechanical stop that selectively prevents actuation of the power trigger 308. The power trigger 308 is operatively coupled to a trigger switch 312 that is electrically coupled to the controller 132. The power trigger 308 is rotatably coupled to the housing 104 about a power trigger pin 316 and movable between a first state corresponding with an off position (FIG. 13), a second state corresponding with a full power position (FIG. 14), and an intermediate state corresponding with an intermediate position (not shown) between the off position and the full-power position. The safety trigger 304 is rotatably coupled to the power trigger 308 about a safety trigger pin 320 and biased towards a locked position. To actuate the trigger mechanism 128 and operate the nibbler 100, a user first depresses the safety trigger 304 to disengage the safety trigger 304 from the housing 104, allowing the power trigger 308 to rotate. The power trigger 308 is then rotated to a desired amount. The trigger switch 312 and controller 132 (FIG. 2) detect the amount of rotation of the power trigger 308 between the off and full-power positions and correlate the amount of rotation to a desired speed of operation of the nibbler 100. More particularly, the trigger switch 312 detects the position of the power trigger 308, and the drive unit 106 progressively increases an output speed (e.g., of the electric motor 160) from the off position, through the intermediate position, and to the full power position.

FIGS. 1, 4, 5, and 15 illustrate the die holder lock 244 in further detail. The die holder lock 244 is disposed on the gearcase 180 and selectively engages a detent 324 within the die holder 224. Engagement between the die holder lock 244 and the detent 324 prevents movement of the die holder 224 during use. In the illustrated embodiment, the die holder 224 includes a detent 324 spaced approximately every 90 degrees about the die holder 224. The die holder 224, therefore, can be oriented in four directions relative to the gearcase 180. The die holder lock 244 includes a plunger base 328 coupled to the gearcase 180, a plunger 332 disposed within the plunger base 328, a fastener, such as a wing nut 336, coupled to the plunger 332. A biasing element 340, such as a Belleville spring washer, encompasses the plunger 332 and is disposed axially between the wing nut 336 and the plunger base 328. A locating detent 344 is also coupled to the gearcase 180 and is positioned adjacent to the plunger base 328. The locating detent 344 includes a locating plunger 348 that is biased into engagement with the wing nut 336. Rotation of the wing nut 336 in a first direction moves the plunger 332 into engagement with the detent 324 of the die holder 224. Rotation of the wing nut 336 in a second direction, opposite the first direction, disengages the plunger 332 from the die holder 224. The biasing element 340 applies a biasing force on the plunger 332 in a direction away from the die holder 224.

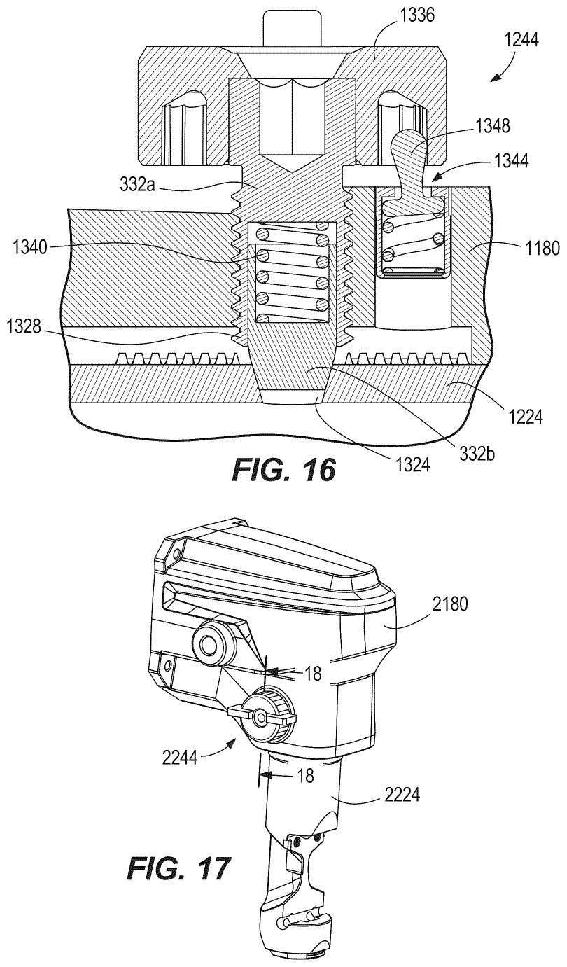

FIG. 16 illustrated another embodiment of a die holder lock 1244, with like parts having like reference numerals plus “1000,” and the following differences explained below. The plunger 1332 is a two-piece assembly including a rotating end 332a coupled to the wing nut 1336 and a locking end 332b to selectively engage the die holder 1224. The rotating end 332a is threadedly coupled to the plunger base 1328. The locking end 332b is disposed within the rotating end 332a and is axially movable relative to the rotating end 332a. The biasing element 1340 is disposed between the rotating end 332a and the locking end 332b to bias the locking end 332b toward engagement with the die holder 1224. Rotation of the wing nut 1336, and thus the rotating end 332a of the plunger 1332, in a first direction compresses the biasing element 1340 and increases a force on the locking end 332b of the plunger 1332. Rotation of the wing nut 1336 in a second direction, opposite the first direction, decompress the biasing element 1340 and decreases the force on the locking end 332b of the plunger 1332. When the biasing force is increased, the locking end 332b of the plunger 1332 is driven into engagement with the detent 1324 of the die holder 1224.

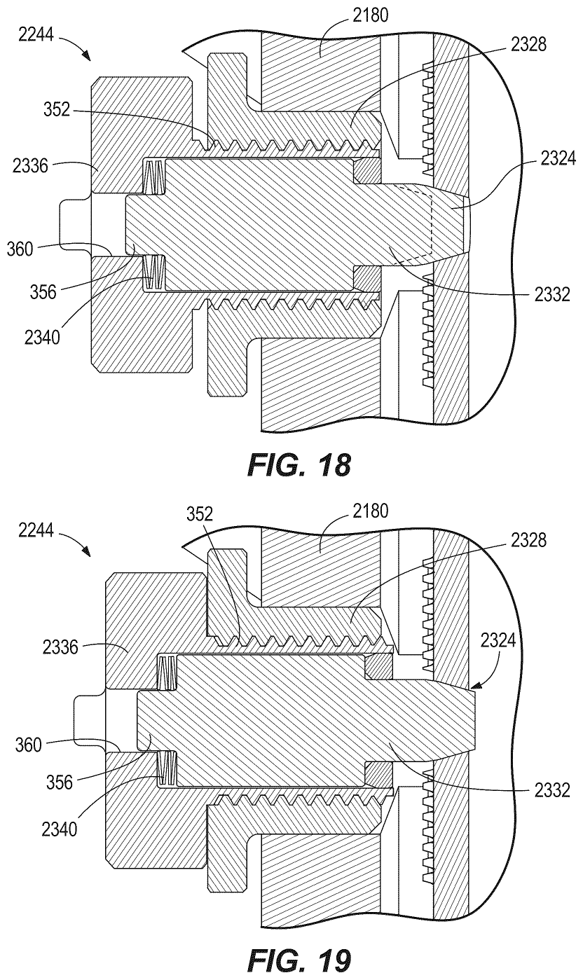

FIGS. 17-19 illustrate another embodiment of a die holder lock 2244, with like parts having like reference numerals plus “2000,” and the following differences explained below. The die holder lock 2244 includes a plunger base 2328 coupled to the gearcase 2180. A plunger 2332 is disposed within the plunger base 2328, and a wing nut 2336 is coupled to the plunger 2332. The wing nut 2336 includes a tubular projection 352 extending therefrom and sized to be threadedly coupled to the plunger base 2328. The tubular projection 352 of the wing nut 2336 is disposed between the plunger 2332 and the plunger base 2328. The plunger 2332 includes a wing nut shaft 356 extending therefrom, and the wing nut 2336 includes a plunger alignment aperture 360 to receive the wing nut shaft 356 and align the plunger 2332 with the wing nut 2336. A biasing element 2340 is disposed about the wing nut shaft 356 and between the plunger 2332 and the wing nut 2336. In the illustrated embodiment, the biasing element 2340 is a Belleville spring washer. As the wing nut 2336 is rotated in the first direction, the wing nut 2336 compresses the spring washer 2340 to increase a force on the plunger 2332 in the engagement direction. The spring washer 2340 preloads the plunger 2332 against the die holder 2224 in response to rotation of the wing nut 2336 relative to the plunger base 2328. In some embodiments, the plunger base 2328 may be integrally formed with the gearcase 2180, rather than being coupled to the gearcase 2180, such that the wing nut 2336 is threadedly coupled to the gearcase 2180.

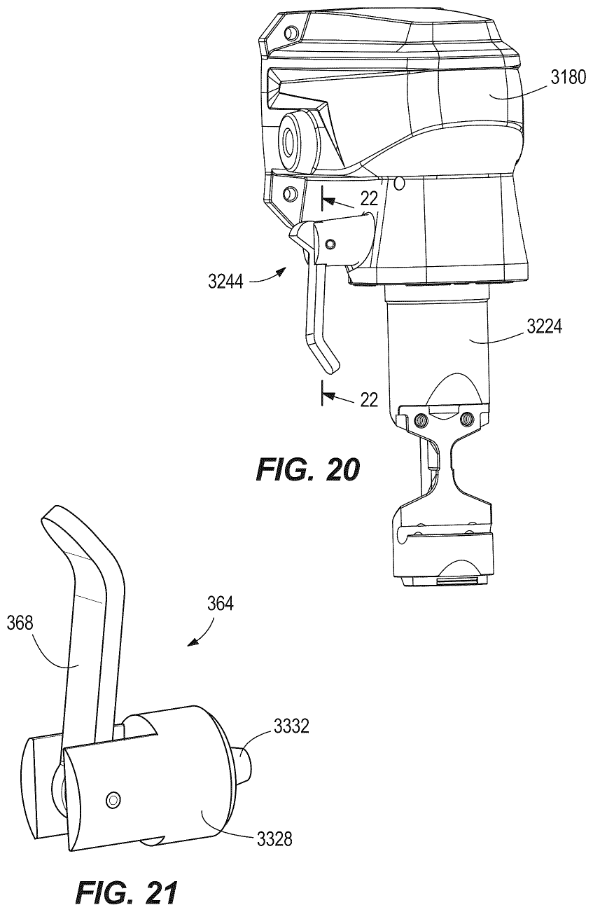

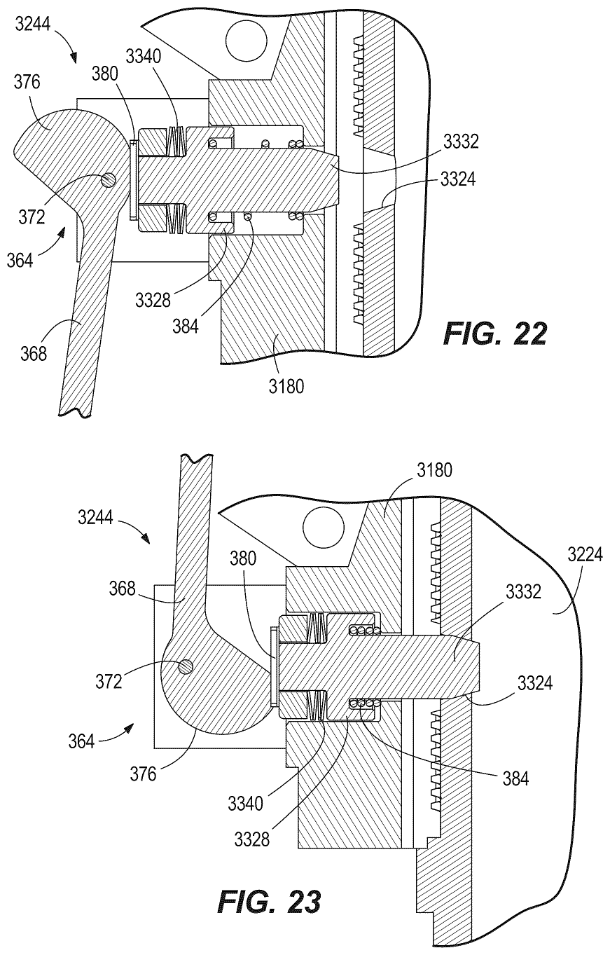

FIGS. 20-23 illustrate yet another embodiment of a die holder lock 3244, with like parts having like reference numerals plus “3000,” and the following different explained below. Rather than utilizing a wing nut to apply a force on the plunger 3332, the die holder lock 3244 includes a cam mechanism 364. The cam mechanism 364 includes a cam 368 rotatable about a cam pin 372. The cam 368 includes a lobe 376 that is engaged with and rotatable relative to a cam plate 380. A first biasing element 3340 is disposed between the cam plate 380 and the plunger 3332 and operates similarly to the biasing element of the previous embodiments.

A second biasing element 384 is disposed between the plunger 3332 and the gearcase 3180. As the cam 368 is rotated toward the locked position, the cam lobe 376 drives the cam plate 380 toward the plunger 3332 such that the first biasing element 3340 increases a force applied to the plunger 3332 in the lock direction.

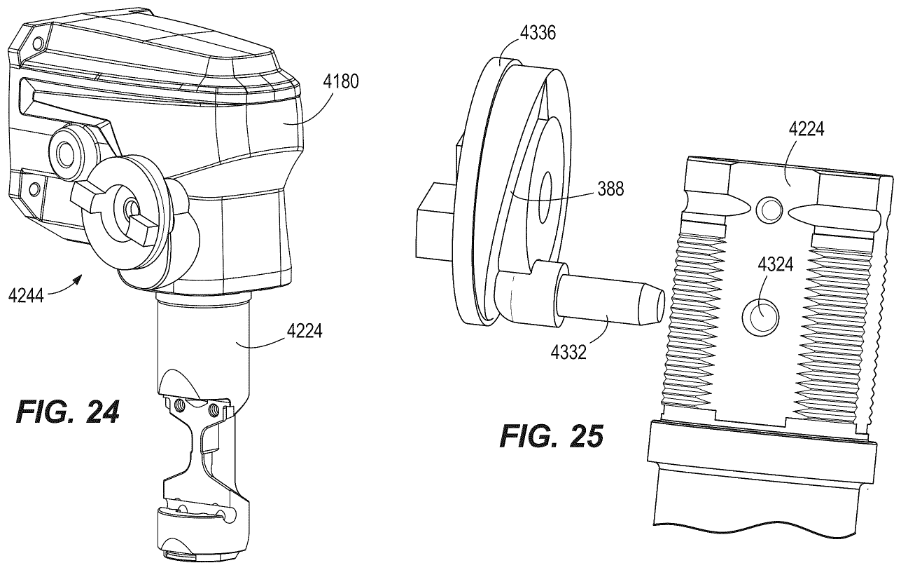

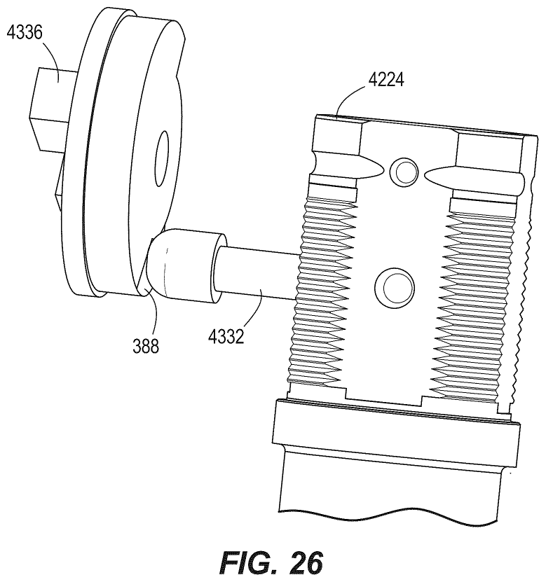

FIGS. 24-26 illustrate yet another embodiment of a die holder lock 4244, with like parts having like reference numerals plus “4000,” and the following differences explained below. The die holder lock 4244 is designed to move between the locked position and the unlocked position by rotating through only 180 degrees. Thus, instead of a threaded wing nut, the wing nut 4336 includes a ramp 388 that is engaged with the plunger 4332. The ramp 388 gradually changes thickness to move the plunger 4332 between locked and unlocked positions with a half turn of the wing nut 4336.

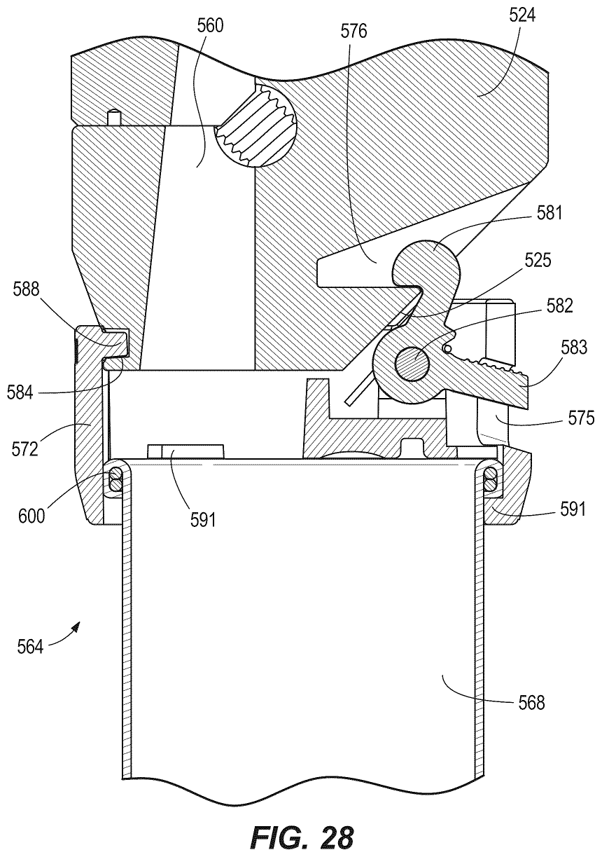

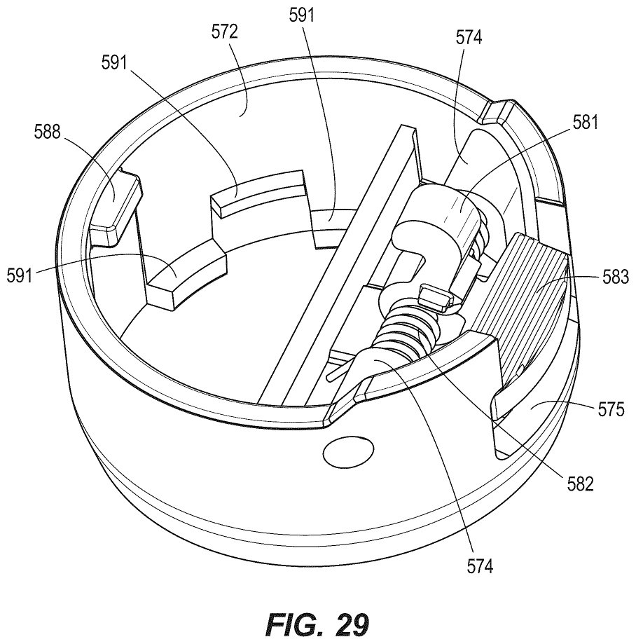

FIGS. 27-29 illustrate an alternative embodiment of a chip bag assembly 564 that may be removably coupled to a die holder 524 (FIG. 28) to collect cut material that is expelled via a chip duct 560. Like components and features of the chip bag assembly 264 and the die holder 224 will be used plus “300.” The chip bag assembly 564 includes a bag 568 and an adapter 572 coupled to the bag 568. The die holder 524 includes a rear lock 576 and a snap feature 584 opposite the rear lock 576. Both the rear lock 576 and the snap feature 584 are recesses that extend into the die holder 524. The adapter 572 includes a snap feature 588 projecting from an inner surface of adapter 572 that is configured to fit within the corresponding snap feature 584 of the die holder 524. The adapter 572 further includes a latch 581 spring-loaded by a torsion spring 582 retained on the adapter 572 by a plurality of posts 574. The latch 581 is biased into engagement with the rear lock 576 by the torsion spring 582 to selectively lock the adapter 572 to the die holder 524. The latch 581 further includes a pressing portion 583 extending through a recess 575 within the adapter 572. When a user depresses the pressing portion 583 of the latch 581, the latch 581 moves radially outward against the bias of the torsion spring 582 and out of engagement with the rear lock 576. Specifically, the latch 581 is moveable between a locking position, in which the adapter 572 is secured to the die holder 524, and a release position, in which the adapter 572 can be removed from the die holder 524.

To secure the adapter 572 and bag 268 to the die holder 524, a user first fits the snap feature 588 of the adapter 572 within the corresponding snap feature 584 on the die holder 524 while simultaneously depressing the pressing portion 583 on the latch 581. Next, while the user is still depressing the pressing portion 583, the user aligns the latch 581 with the rear lock 576. Once the latch 581 is aligned with the rear lock 576, the user releases the pressing portion 583 to move the latch 581 into engagement with the rear lock 576 to secure the adapter 572 and bag 268 to the die holder 524 in the locking position. Alternatively, to secure the adapter 572 and the bag 268 to the die holder 524, the user first fits the snap feature 588 of the adapter 572 within the corresponding snap feature 584 on the die holder 524 as described above. Next, without manually depressing the pressing portion 583 on the latch 581, the user pivots the adapter 572 upward toward a horizontal position, thereby causing the latch 581 to move along an inclined surface 525 on the die holder 524 that is positioned below the rear lock 576. As the latch 581 moves along the inclined surface 525, the latch 581 progressively moves radially outward against the bias of the torsion spring 582 until the latch 581 encounters the rear lock 576, at which time the torsion spring 582 biases the latch 581 into engagement with the rear lock 576 to secure the adapter 572 and the bag 268 to the die holder 524 in the locking position.

In some embodiments, the recess defining the rear lock 576 can be located on the adapter 572, and the latch 581 can be located on the die holder 524 to perform the same functionality (i.e., movement between the release position and the locking position) as detailed above.

With continued reference to FIGS. 27-29, the adapter 572 further includes a plurality of positioning ribs 591 projecting from an inside surface of the adapter 572 to facilitate the connection between the adapter 572 and the bag 568. The ribs 591 are formed as two sets of ribs 591 axially spaced from each other between which a retaining ring 600 of the bag 568 is positioned to secure the bag 568 to the adapter 572.

Although the disclosure has described in detail certain preferred embodiments, variations and modifications exist within the scope and spirit of one or more independent aspects of the invention as described.

Various features of the invention are set forth in the following claims.

1. A handheld punch tool comprising:
a housing including a handle, a battery receptacle disposed at an end of the handle, and a gearcase coupled to the handle opposite the battery receptacle;
a cutting head coupled to the gearcase;
a drive unit disposed within the housing;
a drive train coupled to the drive unit, the drive train including
a transmission operatively coupled to the drive unit to receive torque therefrom, and
a reciprocating mechanism operatively coupled to the transmission, the reciprocating mechanism configured to convert rotational torque from the transmission into a reciprocating motion;
a punch coupled to the reciprocating mechanism to be driven in the reciprocating motion;
a die assembly including
a die holder extending from the housing, and
a die coupled to the die holder; and
a die holder lock coupled to the housing and configured to selectively lock the die holder thereto, the die holder lock including
a plunger base coupled to the gearcase,
a plunger disposed within the plunger base, the plunger configured to selectively engage the die holder to lock the die holder to the gearcase,
a fastener threaded to the plunger base, and
a biasing element disposed between the fastener and the plunger, the biasing element configured to preload the plunger against the die holder in response to rotation of the fastener relative to the plunger base.

2. The handheld punch tool of claim 1, wherein the biasing element is a Belleville spring washer.

3. The handheld punch tool of claim 1, wherein rotation of the fastener in a first direction compresses the biasing element to increase a preload on the plunger.

4. The handheld punch tool of claim 1, wherein the plunger is a two-piece assembly including:
a rotating end coupled to the fastener, the rotating end being threadably coupled to the plunger base, and
a locking end disposed within the rotating end and axially movable relative to the rotating end for selective engagement with die holder.

5. The handheld punch tool of claim 1, wherein the die holder includes a detent configured to selectively receive the plunger.

6. The handheld punch tool of claim 1, wherein the fastener includes a tubular projection for threadably coupling to the plunger base, the tubular projection having an alignment aperture for locating the plunger within the fastener.

7. The handheld punch tool of claim 1, wherein the plunger base is integrally formed with the gearcase.

8. A handheld punch tool comprising:
a housing including a handle, a battery receptacle disposed at an end of the handle, and a gearcase coupled to the handle opposite the battery receptacle;
a cutting head coupled to the gearcase;
a drive unit disposed within the housing;
a drive train coupled to the drive unit, the drive train including
a transmission operatively coupled to the drive unit to receive torque therefrom, and
a reciprocating mechanism operatively coupled to the transmission, the reciprocating mechanism configured to convert rotational torque from the transmission into a reciprocating motion;
a punch coupled to the reciprocating mechanism to be driven in the reciprocating motion;
a die assembly including
a die holder extending from the housing, and
a die coupled to the die holder; and
a chip bag assembly selectively coupled to the die holder, the chip bag assembly including
an adapter configured to be snap-fit to the die holder, and
a chip bag coupled to the adapter, the chip bag configured to collect chips cut by the punch and the die from a sheet of material.

9. The handheld punch tool of claim 8, wherein the die holder includes a plurality of positioning flats having a recess.

10. The handheld punch tool of claim 9, wherein the adapter includes a plurality of positioning protrusions for corresponding with the positioning flats and a projection for corresponding with the recess to form a snap-fit.

11. The handheld punch tool of claim 8, wherein the die holder includes a locking recess extending into the die holder.

12. The handheld punch tool of claim 11, wherein the adapter includes a locking protrusion extending from the adapter configured to be positioned within the locking recess when the adapter is coupled to the die holder.

13. The handheld punch tool of claim 11, wherein the locking recess includes a triangular cross-section.

14. The handheld punch tool of claim 8, wherein the chip bag assembly further includes a retaining ring disposed between the chip bag and the adapter.

15. A handheld punch tool comprising:
a housing including a handle, a battery receptacle disposed at an end of the handle, and a gearcase coupled to the handle opposite the battery receptacle;
a cutting head coupled to the gearcase;
a drive unit disposed within the housing;
a drive train coupled to the drive unit, the drive train including
a transmission operatively coupled to the drive unit to receive torque therefrom, and
a reciprocating mechanism operatively coupled to the transmission, the reciprocating mechanism configured to convert rotational torque from the transmission into a reciprocating motion;
a punch coupled to the reciprocating mechanism to be driven in the reciprocating motion;
a die assembly including
a die holder extending from the housing, and
a die coupled to the die holder;
a chip bag assembly selectively coupled to the die holder, the chip bag assembly including
an adapter, and
a chip bag coupled to the adapter, the chip bag configured to collect chips cut by the punch and the die from a sheet of material;
a latch coupled to one of the adapter or the die holder, the latch movable between a locking position, in which the adapter is secured to the die holder, and a release position, in which the adapter is removable from the die holder; and
a recess defined in the other of the adapter or the die holder in which the latch is receivable in the locking position.

16. The handheld punch tool of claim 15, wherein the adapter includes a biasing member for biasing the latch into engagement with the recess.

17. The handheld punch tool of claim 16, wherein the adapter includes a pressing portion configured to be depressed to pivot the latch radially outward against the biasing force of the biasing member and out of engagement with the recess.

18. The handheld punch tool of claim 15, wherein the adapter includes a plurality of positioning ribs projecting from an inside surface of the adapter for facilitating the connection between the chip bag and the adapter.

19. The handheld punch tool of claim 15, wherein the adapter is configured to be snap-fit to the die holder.

20. The handheld punch tool of claim 19, wherein the adapter includes a first snap feature, and wherein the die holder includes a second snap feature corresponding with the first snap feature to form a snap-fit.

21.-25. (canceled)
